(19) United States
(12) Patent Application Publication
(10) Pub. No.: US 2025/0065777 A1
(43) Pub. Date: Feb. 27, 2025

(54) CUSTOMIZED ACTUATION OF SEAT ACTUATORS

(71) Applicant: Toyota Motor Engineering & Manufacturing North America, Inc., Plano, TX (US)

(72) Inventors: Michael Paul Rowe, Pinckney, MI (US); Brian J. Pinkelman, Ann Arbor, MI (US); Yufei Zhu, Ypsilanti, MI (US); Frederick William Mau, II, McKinney, TX (US); Todd Blickenstaff, La Verne, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/453,395

(22) Filed: Aug. 22, 2023

(51) Int. Cl. B60N 2/00; B60N 2/02

(52) U.S. Cl. CPC B60N 2/0022; B60N 2/0244

(57) ABSTRACT

The actuation of a seat actuator can be customized to provide an enhanced user experience. In one respect, a seat actuation profile can be modified or a new seat actuation profile can be created based on user data, vehicle data, and/or environmental data. The modified seat actuation profile or the new seat actuation profile to be implemented. As a result, one or more actuators operatively connected to a seat can selectively activated or deactivated in accordance with the modified seat actuation profile or the new seat actuation profile. In another respect, an aspects can be identified from a one or more seat actuation profiles and/or one or more seat actuation preferences. A seat actuation profile can be caused to be presented to a user based on the identified aspect.

### FIELD

The subject matter described herein relates in general to seats and, more particularly, to seats that provide a haptic effect.

### BACKGROUND

A vehicle typically includes a plurality of seats. There are numerous vehicle seat designs. Vehicles seats can be contoured and/or can include features to provide support and comfort to a vehicle occupant. Some vehicle seats can include various ergonomic features to enhance user comfort. Some vehicle seats are powered and allow a user to adjust one or more aspects of the seat. Some vehicle seats can provide a haptic effect to a user.

### SUMMARY

In one respect, the present disclosure is directed to a method for seat actuation. The method can include receiving user data relating to a seat actuation profile. The method can also include modifying a seat actuation profile or creating a new seat actuation profile based on the user data. The method can include causing the modified seat actuation profile or the new seat actuation profile to be presented to a user.

In another respect, the present disclosure is directed to a system for seat actuation. The system can include a seat and an actuator operatively connected to the seat. The system can include one or more processors operatively connected to the actuator. The one or more processors can be programmed to initiate executable operations. The executable operations can include receiving user data relating to a seat actuation profile. The executable operations can include modifying a seat actuation profile or creating a new seat actuation profile based on the user data. The executable operations can include causing the modified seat actuation profile or the new seat actuation profile to be presented to a user.

In still another respect, the present disclosure is directed to a seat actuation method. The method can include receiving one or more seat actuation profiles and/or one or more seat actuation preferences from one or more users. The method can include identifying an aspect of the one or more seat actuation profiles and/or the one or more seat actuation preferences. The method can include causing a seat actuation profile to be presented to a user based on the aspect.

In yet another respect, the present disclosure is directed to a system for seat actuation. The system can include one or more processors operatively connected to one or more connected entities. The one or more processors can be programmed to initiate executable operations. The executable operations can include receiving one or more seat actuation profiles and/or one or more seat actuation preferences from one or more users. The executable operations can include identifying an aspect of the one or more seat actuation profiles and/or the one or more seat actuation preferences. The executable operations can include causing a seat actuation profile to be presented to a user based on the aspect.

In still another respect, the present disclosure is directed to a method of seat actuation of a seat in a vehicle. The method can include receiving vehicle data and/or environment data. The method can include modifying a seat actuation profile or creating a new seat actuation profile based on the vehicle data and/or environment data. The method can include causing the modified seat actuation profile or the new seat actuation profile to be presented to a user.

In another respect, the present disclosure is directed to a system for seat actuation. The system can include a sea and an actuator operatively connected to the seat. The system can include one or more processors operatively connected to the actuator. The one or more processors can be programmed to initiate executable operations. The executable operations can include receiving vehicle data and/or environmental data. The executable operations can include modifying a seat actuation profile or creating a new seat actuation profile based on the vehicle data and/or environmental data. The executable operations can include causing the modified seat actuation profile or the new seat actuation profile to be presented to a user.

### BRIEF DESCRIPTION OF THE DRAWINGS

FIG. 1 is an example of a seat.

FIG. 2 is an example of a system for actuation of a seat.

FIG. 3 is an example of a seat actuation system for connected vehicles.

FIG. 4A is an example of a first seat actuation method.

FIG. 4B is an example of a second seat actuation method.

FIG. 5 is an example of a user interface for seat actuators.

FIG. 6A-6C is a first example of a seat actuator.

FIGS. 7A-7B is a second example of a seat actuator.

FIGS. 8A-8B is a third example of a seat actuator.

FIG. 9 is a fourth example of a seat actuator.

### DETAILED DESCRIPTION

Vehicle seats that provide a haptic effect, such as massaging, typically do not offer much flexibility in the haptic output. As a result, the experience is not tailored to the user. According to arrangements described herein, seat actuation profiles can be customized, thereby providing an enhanced user experience. There are various ways in which such customization can be provided. For instance, the customization can be done locally (e.g., onboard a vehicle) based on user data of a particular user or based on vehicle data. An existing seat actuation profile can be modified or a new seat actuation profile can be created based on the user data or the vehicle data. The modified seat actuation profile or the new seat actuation profile can be presented to the user. Alternatively, the customization can be done remotely, such as by a remote server or other remote computing system, relative to a population of users. For instance, an aspect can be identified from one or more seat actuation profiles and/or one or more seat actuation preferences from one or more users. A seat actuation profile can be caused to be presented to a user based on the identified aspect.

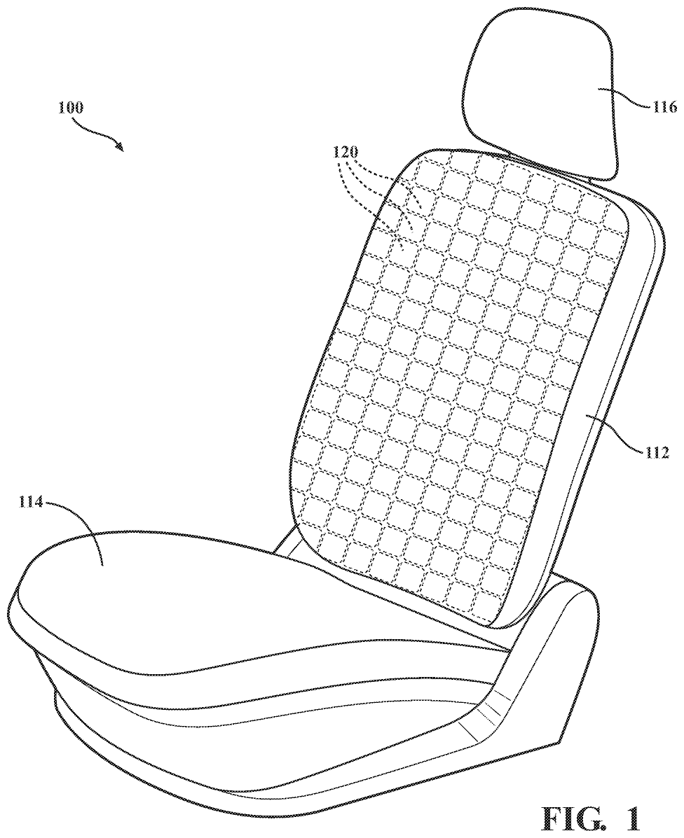

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example of a seat 100 is shown. In one or more arrangements, the seat 100 can be a vehicle seat. The seat 100 can be any type of vehicle seat, now known or later developed. The seat 100 can be for any vehicle occupants, such for a driver and/or for a passenger. The seat will be described herein with respect to a vehicle seat, but it will be appreciated that arrangements are not limited to vehicle seats. Indeed, the seat 100 can be an office chair, a chair, a massage chair, a gaming chair, a recliner, or any other seat structure, now known or later developed.

The seat 100 can have any suitable configuration. For instance, the seat 100 can include a back portion 112 and a seat portion 114. The back portion 112 and/or the seat portion 114 can include bolsters. In some arrangements, the seat 100 can include a headrest 116 and/or arm rests.

The seat 100 can include one or more seat actuators 120. The one or more seat actuators 120 can be operatively positioned relative to one or more surfaces or portions of the seat 100. The one or more surfaces can be a surface of the back portion 112, the seat portion 114, a bolster of the back portion 112, a bolster of the seat portion 114, headrest 116, an arm rest, or any combination or subset thereof.

In some arrangements, there can be a single seat actuator 120 associated with the seat 100. In some arrangements, there can be a plurality of seat actuators 120 associated with the seat 100. The seat actuator(s) 120 can be operatively connected to the seat 100. In one or more arrangements, the seat actuator(s) 120 can be located within a portion of the seat 100. For instance, the seat actuator(s) 120 can be located within the back portion 112, the seat portion 114, the bolster of the back portion 112, the bolster of the seat portion 114, the headrest 116, one or more arm rests, or any combination or subset thereof. When actuated, the seat actuator(s) 120 can cause the surfaces or portions of the seat 100 to morph into a different configuration and/or the seat actuator(s) 120 can provide a physical sensation to an occupant of the seat 100.

In arrangements in which there is a plurality of seat actuators 120, the plurality of seat actuators 120 can be substantially identical to each other. Alternatively, one or more of the seat actuators 120 can be different from the other seat actuators 120 in one or more respects, such as size, shape, configuration, actuation effect, etc. The plurality of seat actuators 120 can be distributed in any suitable manner with respect to the relevant portion of the seat 100. In some instances, the plurality of seat actuations 120 can be arranged in one or more rows and/or one or more columns. In some instances, the plurality of seat actuators 120 can be arranged in a plurality of discrete areas, which may or may not be spaced apart.

The seat actuator(s) 120 can be any element or combination of elements operable to modify, adjust and/or alter one or more surfaces or portions of the seat 100. In FIG. 1, the seat actuator(s) 120 are generally represented by a rectangular feature. It will be understood that the seat actuator(s) 120 can be any suitable type of actuator, now known or later developed.

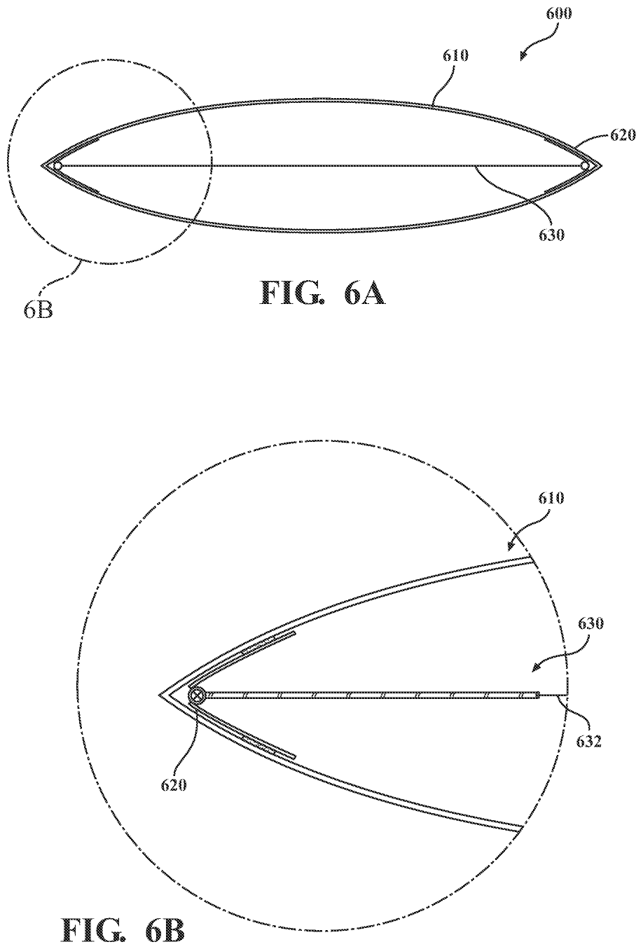

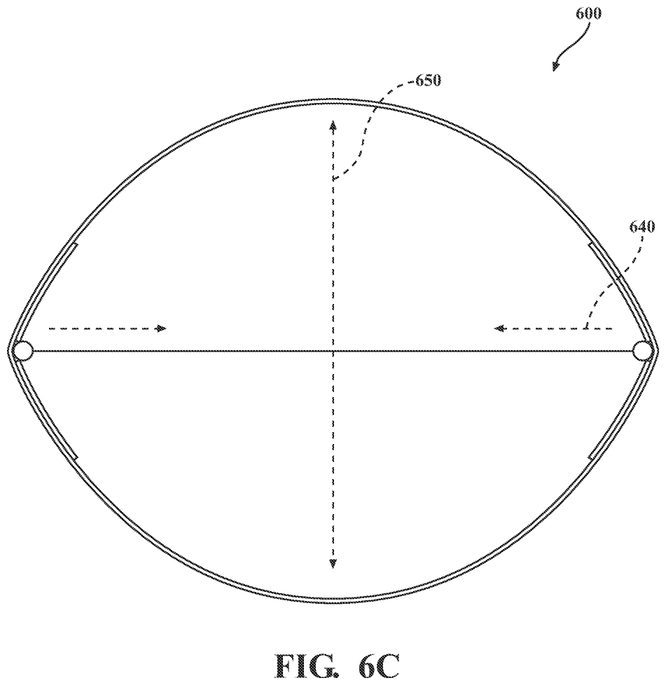

In some arrangements, the seat actuator(s) 120 can include a contracting member. When an activation input is provided to the contracting member, the contracting member can contract, thereby causing the seat actuator(s) 120 to morph into an activated configuration in which the height of the actuator increases. In some arrangements, the contracting member can be a shape memory material member, which can include shape memory alloys and shape memory polymer. As an example, the contracting member can be a shape memory alloy wire. Various non-limiting examples of suitable actuators are shown in FIGS. 6-9, and they will be described in greater detail herein.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members can be shape memory material wires. As an example, the shape memory material members can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 150 MPA to about 400 MPa. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). One example of a nickel-titanium shape memory alloy is FLEXINOL, which is available from Dynaolloy, Inc., Irvine, California. As a further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the shape memory material members are described, in some implementations, as being wires, it will be understood that the shape memory material members are not limited to being wires. Indeed, it is envisioned that suitable shape memory materials may be employed in a variety of other forms, such as sheets, plates, panels, strips, cables, tubes, or combinations thereof. In some arrangements, the shape memory material members may include an insulating coating.

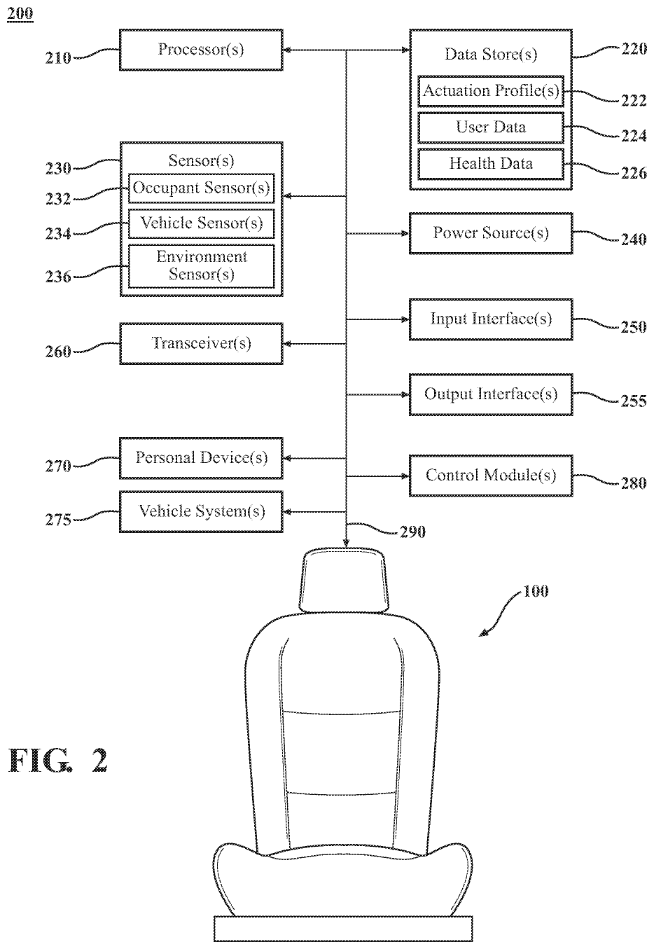

Referring to FIG. 2, an example of a system 200 for actuation of the seat 100 is shown. In some arrangements, the system 200 can be used in connection with a vehicle. As used herein, “vehicle” means any form of transport, including motorized or powered transport. In one or more implementations, the vehicle can be an automobile. While arrangements will be described herein with respect to automobiles, it will be understood that embodiments are not limited to automobiles. In some implementations, the vehicle may be a watercraft, an aircraft, spacecraft, or any other form of transport.

The system 200 can include various elements. Some of the possible elements of the system 200 are shown in FIG. 2 and will now be described. It will be understood that it is not necessary for the system 200 to have all of the elements shown in FIG. 2 or described herein. The system 200 can have any combination of the various elements shown in FIG. 2. Further, the system 200 can have additional elements to those shown in FIG. 2. In some arrangements, the system 200 may not include one or more of the elements shown in FIG. 2. Further, while the various elements may be located on or within a vehicle, it will be understood that one or more of these elements can be located external to the vehicle. Thus, such elements are not located on, within, or otherwise carried by the vehicle. Further, the elements shown may be physically separated by large distances. Indeed, one or more of the elements can be located remote from the vehicle, such an on a remote server or cloud-based server.

In addition to the seat 100 and the seat actuator(s) 120, the system 200 can include one or more processors 210, one or more data stores 220, one or more sensors 230, one or more power sources 240, one or more input interfaces 250, one or more output interfaces 255, one or more transceivers 260, one or more personal device(s) 270, one or more vehicle systems, and/or one or more control modules 280. Each of these elements will be described in turn below.

As noted above, the system 200 can include one or more processors 210. “Processor” means any component or group of components that are configured to execute any of the processes described herein or any form of instructions to carry out such processes or cause such processes to be performed. The processor(s) 210 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 210 can include at least one hardware circuit (e.g., an integrated circuit) configured to carry out instructions contained in program code. In arrangements in which there is a plurality of processors 210, such processors can work independently from each other or one or more processors can work in combination with each other.

The system 200 can include one or more data stores 220 for storing one or more types of data. The data store(s) 220 can include volatile and/or non-volatile memory. Examples of suitable data stores 220 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 220 can be a component of the processor(s) 210, or the data store(s) 220 can be operatively connected to the processor(s) 210 for use thereby. The term “operatively connected,” as used throughout this description, can include direct or indirect connections, including connections without direct physical contact.

In some arrangements, the data store(s) 220 can store one or more actuation profiles 222. The actuation profile(s) 222 can include instructions for activating one or more seat actuators 120 in a specified manner. The actuation profile(s) 222 can include activation patterns, activation sequences, activation zones, activation regions, activation times, activation of individual actuators or groups of actuators, etc. The actuation profile(s) 222 can be created by an end user, a seat manufacturer, a vehicle manufacturer, or some other entity (e.g., such as a wellness or medical provider, service, or business). In some instances, one or more actuation profile(s) 222 can be received from a remote source. In some arrangements, one or more actuation profile(s) 222 can be associated with a particular health condition or state or context of a seat occupant.

In one or more arrangements, the data store(s) 220 can store user data 224. The user data 224 can include user preferences with respect to the seat actuators 120. Such preferences can include likes and/or dislikes about a particular actuation profile or a portion of an actuation profile. Such preferences can include preferred strength, duration, areas, timing, patterns, and/or other factors with respect to the seat actuators 120. The preferences can include areas to avoid. The user data 224 can include a user's actuation profile usage history or massage profile history. The user data 224 can include user context data.

In one or more arrangements, the data store(s) 220 can store user health data 226. The user health data 226 can include conditions, symptoms, diagnoses, treatment, etc. The user health data 226 may be general health-related data and/or with respect to a particular user. In one or more arrangements, the data store(s) 220 can store health thresholds, profiles, and/or preferences. In one or more arrangements, the data store(s) 220 can store user biodata or user health data acquired by one or more elements of the system 200.

The system 200 can include one or more sensors 230. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 200 includes a plurality of sensors 230, the sensors can work independently from each other. Alternatively, two or more of the sensors can work in combination with each other. In such case, the two or more sensors can form a sensor network. The sensor(s) 230 can be operatively connected to the processor(s) 210, the data store(s) 220, and/or other elements of the system 200 (including any of the elements shown in FIG. 1).

The sensor(s) 230 can include any suitable type of sensor, now known or later developed. The sensor(s) 230 can include one or more seat occupant sensors 232. The seat occupant sensor(s) 232 can include one or more biosensors, which can be configured to acquire biodata of a user (i.e., a human being). Biodata includes any biological data, biomarkers, physiological data, and/or psychological data that can be analyzed to determine a state or condition of a user, such as a comfort level or a health condition. Non-limiting examples of the biodata can include sweat glucose (to monitor blood sugar), blood pressure, galvanic skin response (to measure degrees of arousal), sodium and potassium (to measure dehydration), among others. In some arrangements, the biosensor(s) can be configured to acquire biodata by direct contact with a body portion of a human being, such as a portion of a human's hand, finger, or thumb.

The sensor(s) 230 can include one or more vehicle sensors 234. The vehicle sensor(s) 234 can be configured to detect, determine, assess, monitor, measure, quantify and/or sense information about a vehicle itself (e.g., position, orientation, speed, heading, etc.). In one or more arrangements, the vehicle sensors 234 can include one or more vehicle speed sensors, one or more steering angle sensors, and/or one or more accelerometers. The vehicle speed sensors can be any sensor configured to detect, determine, assess, monitor, measure, quantify and/or sense the speed of a vehicle, now known or later developed. The steering angle sensors can be any sensor configured to detect, determine, assess, monitor, measure, quantify and/or sense the steering wheel position angle and/or rate of turn, now known or later developed. The accelerometers can include any sensor, now know or later developed, configured to detect, determine, assess, monitor, measure, quantify and/or sense any information or data about acceleration forces experience by a vehicle or occupants of the vehicle, including lateral acceleration forces.

The sensor(s) 230 can include one or more environmental sensors 236 configured to detect, determine, assess, monitor, measure, quantify, acquire, and/or sense environmental data. Environmental data can include external environment data and/or internal environment data. “External environment data” includes data or information about the external environment in which a vehicle is located or one or more portions thereof. Some non-limiting examples of the environmental sensor(s) 236 configured to acquire external environment data can include one or more cameras, one or more radar sensors, one or more lidar sensors, one or more sonar sensors, and/or one or more ranging sensors.

Further non-limiting examples of the environmental sensor(s) 236 configured to acquire external environment data can include one or more weather sensors, one or more temperature sensors, one or more air particulate sensors, one or more air quality sensors, one or more humidity sensors, one or more wind speed sensors, one or more wind angle sensors, one or more wind direction sensors, one or more rain sensors, one or more moisture sensors, one or more light sensors, one or more anemometers, one or more hygrometers, one or more barometers, one or more fog sensors, one or more visibility sensors, one or more motion sensors, and/or one or more cameras, just to name a few examples.

“Internal environment data” includes data or information about the environment within a vehicle (e.g., the cabin) or one or more portions thereof. In one or more arrangements, non-limiting examples of the environmental sensor(s) 236 configured to acquire internal environment data can include one or more ambient noise sensors, one or more microphones, one or more temperature sensors, one or more air particulate sensors, one or more air quality sensors, one or more humidity sensors, one or more moisture sensors, one or more light sensors, and/or one or more cameras, just to name a few examples.

As noted above, the system 200 can include one or more power sources 240. The power source(s) 240 can be any power source capable of and/or configured to energize the seat actuator(s) 120, as will be described later. For example, the power source(s) 240 can include one or more batteries, one or more fuel cells, one or more generators, one or more alternators, one or more solar cells, and combinations thereof. The power source(s) 240 can be any suitable source of electrical energy.

The system 200 can include one or more input interfaces 250. An “input interface” includes any device, component, system, element or arrangement or groups thereof that enable information/data to be entered into a machine. The input interface(s) 250 can receive an input from a vehicle occupant (e.g. a driver or a passenger). Any suitable input interface 250 can be used, including, for example, a keypad, gesture recognition interface, voice recognition interface, display, touch screen, multi-touch screen, button, joystick, mouse, trackball, microphone and/or combinations thereof.

The system 200 can include one or more output interfaces 255. An “output interface” includes any device, component, system, element or arrangement or groups thereof that enable information/data to be presented to a vehicle occupant (e.g. a person, a vehicle occupant, etc.). The output interface(s) 255 can present information/data to a vehicle occupant. The output interface(s) 255 can include a display. Alternatively or in addition, the output interface(s) 255 may include an earphone and/or speaker. Some components of the system 200 may serve as both a component of the input interface(s) 250 and a component of the output interface(s) 255.

The system 200 can include one or more transceivers 260. As used herein, “transceiver” is defined as a component or a group of components that transmit signals, receive signals or transmit and receive signals, whether wirelessly or through a hard-wired connection. The transceiver(s) 260 can enable communications between the system 200 (and/or vehicle), a personal device, a vehicle, and/or other elements of a larger system. The transceiver(s) 260 can be any suitable transceivers used to access a network, access point, node or other device for the transmission and receipt of data. The transceiver(s) 260 may be wireless transceivers using any one of a number of wireless technologies, now known or in the future.

The system 200 can include one or more personal devices 270. The personal device(s) 270 can include any portable device worn or carried by a person, now known or later developed. Examples of the personal device(s) 270 can include a telephone (e.g., a cellular telephone, a smart phone, etc.), a personal digital assistant (“PDA”), a computer (e.g., a laptop, a tablet, a phablet, etc.), a fitness tracker, a sleep monitor, a physical fitness monitor, an activity tracker, a handheld device having wireless connection capability, a pedometer, a heart rate monitor, a sleep quality monitor, a wellness monitor, a stair climber monitor, a step monitor, an entertainment device (e.g., an audio or video device) and/or any other a portable computing device. In one or more arrangements, the personal device(s) 270 can be configured so as to be wearable by a user. For instance, the personal device(s) 270 can be a smart watch, smart eyeglasses, smart jewelry (e.g., neckless, earrings, bracelets, etc.), smart contact lenses, and/or smart clothing (e.g., a shirt, hat, or other article of clothing enabled for wireless communication). The personal device(s) 270 can have any suitable application software or computer programs running thereon. The personal device(s) 270 can be configured to communicate with the vehicle via a wireless medium.

The personal device(s) 270 can include one or more sensors, now known or later developed, for detecting data about a person associated with the personal device(s) 270. In one or more arrangements, the personal device(s) 270 (or a program executed thereon) can be configured to monitor the sleep of a user. In some instances, the personal device(s) 270 can be configured to assign a sleep score to the user based on an analysis of the user's sleep. The personal device(s) 270 can be configured to monitor a user's lifestyle and/or life activities. For instance, the personal device(s) 270 can be configured to understand a location of a user and/or movement of a user. For instance, the personal device(s) 270 can recognize that a user was on a flight or that the user may be jetlagged. The personal device(s) 270 can be configured to monitor a user's activities, such as being at a gym, workout activities, etc. In some instances, the personal device(s) 270 can understand where a user is or has been using a map application or by a calendar entry. These and other data can be considered to be user context data, which can include any data about a user that can be useful for tailoring an actuation profile to a user.

The system 200 can include one or more vehicle systems 275. Examples of the one or more vehicle systems 275 include a propulsion system, a braking system, a steering system, throttle system, a transmission system, a signaling system, an infotainment system, a safety system, a communication system, and/or a navigation system, just to name a few possibilities. The safety system can include a lane assist system, an advanced driver-assistance system, a collision avoidance system, an adaptive or autonomous cruise control system, an airbag system, a blind spot warning system, a blind spot monitoring system, a backup camera system, a lane keeping assist system, and/or any other safety related system, now known or later developed. The vehicle system(s) 275 can collect data about their usage, performance, and/or other data. Such data can be used in accordance with the arrangements described herein.

Each of these systems can include one or more mechanisms, devices, elements, components, systems, and/or combination thereof, now known or later developed. However, the system 200 can include more, fewer, and/or different vehicle systems. It should be appreciated that although particular vehicle systems are separately defined, each or any of the systems or portions thereof may be otherwise combined or segregated via hardware and/or software within a vehicle.

The system 200 can include one or more modules, at least some of which will be described herein. The modules can be implemented as computer readable program code that, when executed by a processor, implements one or more of the various processes described herein. One or more of the modules can be a component of the processor(s) 210, or one or more of the modules can be executed on and/or distributed among other processing systems to which the processor(s) 210 is operatively connected. The modules can include instructions (e.g., program logic) executable by one or more processor(s) 210. Alternatively or in addition, one or more data stores 220 may contain such instructions. In some arrangements, the module(s) can be located remote from the other elements of the system 200.

In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 200 can include one or more control modules 280. The control module(s) 280 can include profiles and logic for controlling the seat actuators 120. The control module(s) 280 can use profiles, parameters, or settings loaded into the control module(s) 280 and/or stored in the data store(s) 220, such as the actuation profiles 222. In some arrangements, the control module(s) 280 can be located remotely from the other elements of the system 200, such as on a remote server, a cloud-based server, or an edge server.

The control module(s) 280 can be configured to cause one or more of the seat actuators 120 to be activated or deactivated. As used herein, “cause” or “causing” means to make, force, compel, direct, command, instruct, and/or enable an event or action to occur or at least be in a state where such event or action may occur, either in a direct or indirect manner. For instance, the control module(s) 280 can cause the seat actuators 120 to be selectively activated or deactivated in any suitable manner. For instance, when the seat actuators 120 include a shape memory material member, the shape memory material member can be heated by the Joule effect by passing electrical current through the shape memory material member. To that end, the control module(s) 280 can be configured to selectively permit, restrict, adjust, alter, and/or prevent the flow of electrical energy from the power source(s) 240 (or any other form of energy from any other suitable source) to the one or more shape memory material members of the seat actuators 120. The control module(s) 280 can be configured to send control signals or commands over the communication network 290 to the shape memory material members or to other elements of the system 200.

The control module(s) 280 can be configured to cause the seat actuators 120 to be activated or deactivated based on various events, conditions, inputs, or other factors. For instance, the control module(s) 280 can be configured to cause the seat actuators 120 to be activated or deactivated based on a user input. A user can provide an input on the input interface(s) 250. The input can be a command to implement one of the actuation profiles 222. The input can be a command to activate or deactivate the seat actuators 120 based on the previously used actuation profile or a default actuation profile. In some instances, the input can be a newly defined actuation profile.

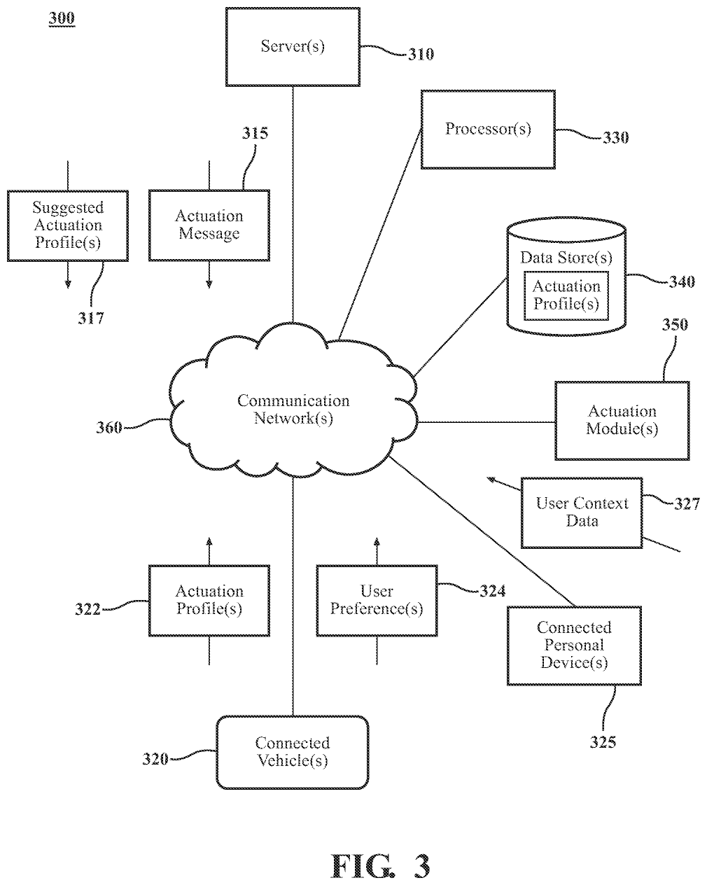

In some arrangements, the control module(s) 280 can be configured to cause the seat actuators 120 to be activated or deactivated based on a suggested actuation profile. The suggested actuation profile can be received from the system 200 or a remote system (e.g., system 300-see FIG. 3). The suggested actuation profile can be implemented automatically by the control module(s) 280. Alternatively, the control module(s) 280 can prompt the user for approval to implement the suggested actuation profile. In some instances, the user can provide feedback on the suggested actuation profile by providing inputs on the input interface(s) 250. The feedback can include the user's rating or feelings about the suggested actuation profile overall or one or more portions of the suggested actuation profile. In some instances, the user can provide feedback in the form of “likes” or “dislikes” or any other suitable form based on the current sensation provided by the seat actuators 120. Such inputs can be saved in the user data 224 in the data store(s) 220.

In some arrangements, the control module(s) 280 can be configured to determine an appropriate action for the seat actuators 120. The control module(s) 280 can be configured to do so in any suitable manner. For instance, the control module(s) 280 can analyze a user's actuation profile usage history, a user's preferences, user context data, or other user data. Based on these and/or other sources, the control module(s) 280 can select, create, or predict an actuation profile that may be suitable for the user.

In other arrangements, the control module(s) 280 can be configured to determine an appropriate action for the seat actuators 120 based on a user's health state, condition, user context data or data. For instance, the control module(s) 280 can be configured to analyze data or information acquired by the sensor(s) 130 (e.g., the seat occupant sensor(s) 232) to select, create, or predict an actuation profile that may be suitable for the user. In this way, arrangements described herein can support the wellness of a user.

The control module(s) 280 can include profiles and logic for determining a health state or condition of a user. More particularly, the control module(s) 280 can include profiles and logic for determining a health state or condition of a user relative to things that can be addressed, alleviated, or helped in some manner by the effect of the seat actuators 120 (e.g., a massaging effect). The control module(s) 280 can be configured to do so in any suitable manner. For instance, the control module(s) 280 can be configured to analyze user data acquired by the seat occupant sensor(s) 232 and/or from the personal device(s) 270. In some instances, the control module(s) 280 may take into account other inputs, such as user inputs provided on the input interface(s) 250. The control module(s) 280 can retrieve raw data from the seat occupant sensor(s) 232 and/or from the data store(s) 220. The control module(s) 280 can also retrieve medical data from any suitable data source, such as from the data store(s) 220 (e.g., the user health data 226) and/or from one or more remote sources of medical data or information.

The control module(s) 280 can analyze the user data acquired by the sensor(s) 230 to detect a health condition or state. For instance, the control module(s) 280 can compare the acquired user data to a library of health conditions or state (e.g., user health data 226) to determine which health condition(s) the user may have and/or eliminate which health condition(s) the user does not have or which health state(s) the user is not in. Further, the control module(s) 280 can compare the acquired user data to symptoms of various health conditions or state. The control module(s) 280 can be configured to use big data to detect a health condition.

In some arrangements, the user data can include weight, glucose levels, blood pressure, alertness, sleepiness, etc. If no health condition or state is detected, the control module(s) 280 may take no action. Further, if a health condition or state is detected but it cannot be addressed, alleviated, or helped by the seat actuators 120, then the control module(s) 280 may take no action. However, in such case, the control module(s) 280 can alert a user to the detected health condition or state. When a health condition or state is detected, particularly when it is one that can be addressed, alleviated, or helped by the seat actuators 120, the control module(s) 280 can determine an appropriate actuation profile to relieve the detected health condition or health state.

In some arrangements, the control module(s) 280 can be configured to analyze user context data acquired from the personal device(s) 270. For instance, the control module(s) 280 may determine that the user was just at the gym and may be able to determine which parts of the body the user exercised. In such case, the control module(s) 280 can be configured to provide a massaging effect to those areas that were exercised and/or to provide a reduced strength of massaging effect in such areas. As another example, the control module(s) 280 can determine that the user was recently on a long flight (such as an international flight or any flight over a predetermined amount of time). In such case, the control module(s) 280 can determine an actuation profile to provide a massaging effect to the user in areas of the body that are likely to be sore or cramped from a long flight.

In one or more arrangements, the control module(s) 280 can be configured to cause a warning to be presented to the user if warranted based on the detected health condition or heath state. In one or more arrangements described herein, the control module(s) 280 can be configured to cause the output interface(s) 255 and/or other component of the system 200 to be activated to provide a warning. The warning can be any type of warning, including, for example, a visual warning, an audial warning, or a haptic warning. The content of the warning and/or the manner in which it is output to the user can vary depending on the urgency level of a detected health condition.

In some arrangements, the control module(s) 280 can be configured to control the seat actuators 120 based on vehicle data received from the vehicle sensor(s) 234, environmental data received from the environmental sensor(s) 236, and/or data or received from the vehicle system(s) 275. The control module(s) 280 can be configured to do so in any suitable manner. For instance, the control module(s) 280 can analyze the vehicle data, the environmental data, and/or the data from the vehicle systems(s) 275 to select, create, or predict an actuation profile that may be suitable for the user. In some arrangements, the control module(s) 280 can be configured to select, create, or predict an actuation profile that may be suitable for the user using user data and one or more of the vehicle data, the environmental data, and/or the data from the vehicle systems(s) 275

The various elements of the system 200 can be communicatively linked to one another or one or more other elements through one or more communication networks 290. As used herein, the term “communicatively linked” can include direct or indirect connections through a communication channel, bus, pathway or another component or system. A “communication network” means one or more components designed to transmit and/or receive information from one source to another. The data store(s) 220 and/or one or more other elements of the system 200 can include and/or execute suitable communication software, which enables the various elements to communicate with each other through the communication network and perform the functions disclosed herein.

The one or more communication networks 290 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

FIG. 3 is an example of a seat actuation system 300. Some of the possible elements of the seat actuation system 300 are shown in FIG. 3 and will now be described. It will be understood that it is not necessary for the seat actuation system 300 to have all of the elements shown in FIG. 3 or described herein. The seat actuation system 300 can include one or more servers 310, one or more connected vehicles 320, one or more connected personal devices 325, one or more processors 330, one or more data stores 340, and one or more actuation module(s) 350.

The various elements of the seat actuation system 300 can be communicatively linked through one or more communication networks 360. The communication network(s) 360 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network(s) 360 further can be implemented as or include one or more wireless networks, whether short or long range. For example, in terms of short range wireless networks, the communication network(s) 360 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long range wireless networks, the communication network(s) 360 can include a mobile, cellular, and or satellite-based wireless network and support voice, video, text, and/or any combination thereof. Examples of long range wireless networks can include GSM, TDMA, CDMA, WCDMA networks or the like. The communication network(s) 360 can include wired communication links and/or wireless communication links. The communication network(s) 360 can include any combination of the above networks and/or other types of networks. The communication network(s) 360 can include one or more routers, switches, access points, wireless access points, and/or the like. In one or more arrangements, the communication network(s) 360 can include Vehicle-to-Vehicle (V2V), Vehicle-to-Infrastructure (V2I), Vehicle-to-Cloud (V2C), or Vehicle-to-Everything (V2X) technology, which can allow for communications between the connected vehicle(s) 320, the and/or the server(s) 310.

One or more elements of the seat actuation system 300 include and/or can execute suitable communication software, which enables two or more of the elements to communicate with each other through the communication network(s) 360 and perform the functions disclosed herein.

As noted above, the seat actuation system 300 can include one or more servers 310. The server(s) 310 can be located remote from the connected vehicle(s) 320 and/or the connected entities 140. The server(s) 310 can be any type of server, now known or later developed. In some arrangements, the server(s) 310 can be cloud-based server(s) or edge server(s). The server(s) 310 can communicate with the connected vehicles 320 over the communication network(s) 360.

The connected vehicle(s) 320 will now be described in greater detail. The term “vehicle” means any form of motorized transport, now known or later developed. Non-limiting examples of vehicles include automobiles, motorcycles, aerocars, or any other form of motorized transport. While arrangements herein will be described in connection with land-based vehicles, it will be appreciated that arrangements are not limited to land-based vehicles. Indeed, in some arrangements, the vehicle can be water-based, air-based, or space-based vehicles. The connected vehicle(s) 320 may be operated manually by a human driver, semi-autonomously by a mix of manual inputs from a human driver and autonomous inputs by one or more vehicle computers, fully autonomously by one or more vehicle computers, or any combination thereof. The connected vehicle(s) 320 are “connected” in that they communicatively coupled to the server(s) 310, the processor(s) 330, and/or the actuation module(s) 350. Each of the connected vehicles 320 can include the various elements shown in FIG. 2 or any subset thereof.

The connected personal device(s) 325 can be any of the personal devices 270 described in connection with FIG. 2. The connected personal device(s) 325 are “connected” in that they communicatively coupled to the server(s) 310, the processor(s) 330, and/or the actuation module(s) 350.

As noted above, the seat actuation system 300 can include one or more processors 330 and one or more data stores 340. The above discussion of the processor(s) 210 and the data store(s) 220 in connection with FIG. 2 applies equally to the processor(s) 330 and the data store(s) 340 In some arrangements, the processor(s) 330 and/or the data store(s) 340 can be a part of the server(s) 310.

The seat actuation system 300 can include one or more actuation modules 350. The actuation module(s) 350 can be implemented as computer readable program code that, when executed by a processor, implements one or more of the various processes described herein. The actuation module(s) 350 and/or the data store(s) 340 can be components of the processor(s) 330 and/or the server(s) 310. In one or more arrangements, the actuation module(s) 350 and/or the data store(s) 340 can be stored on, accessed by and/or executed on the processor(s) 330 and/or server(s) 310. In one or more arrangements, the actuation module(s) 350 and/or the data store(s) 340 can be executed on and/or distributed among other processing systems to which the processor(s) 330 and/or server(s) 310 are communicatively linked. In one or more arrangements, the actuation module(s) 350 can include artificial or computational intelligence elements, e.g., neural network, fuzzy logic or other machine learning algorithms.

The actuation module(s) 350 can include instructions (e.g., program logic) executable by a processor. Alternatively or in addition, one or more of the data stores 340 may contain such instructions. Such instructions can include instructions to execute various functions and/or to transmit data to, receive data from, interact with, and/or control one or more elements of the seat actuation system 300. Such instructions can enable the various elements of the seat actuation system 300 to communicate through the communication network(s) 360.

The actuation module(s) 350 can be configured to receive actuation profile(s) 322, user preference(s) 324, other data relating to the use of the seat actuators, or any combination thereof from the connected vehicle(s) 320. These items can be sent to the actuation module(s) 350 automatically by the connected vehicle(s) 320, in response to a user command, in response to an inquiry sent by the actuation module(s) 350, or at any other time.

The actuation profile(s) 322, user preference(s) 324, other data relating to the use of the seat actuators received from the connected vehicle(s) 320 can be used for any suitable purposes. In some instances, the actuation profile(s) 322, user preference(s) 324, user context data 327, and/or other data relevant to the use of the seat actuators can be stored in the data store(s) 340 for later review and/or analysis.

The actuation module(s) 350 can be configured to analyze actuation profile(s) 322, user preference(s) 324, the user context data 327, and/or other data relating to the use of the seat actuators. In some instances, actuation module(s) 350 can be configured to analyze the received data to detect and/or identify an aspects in the received data. The aspect can includes patterns, popularity, trends, averages or other statistical measures, or other noteworthy aspects in the data. The actuation module(s) 350 can be configured to perform statistical analyses on the data.

The actuation module(s) 350 can be configured to associate information about the connected vehicle(s) 320 and/or the occupant(s) of the connected vehicle(s) 320 and associate such information with the received actuation profile(s) 322, user preference(s) 324, other data relating to the use of the seat actuators. For instance, the actuation module(s) 350 can be configured to keep track of which actuation profile(s) and/or user preferences are being used in connection with a particular make, model, year, and/or manufacturer of the connected vehicle(s) 320. As another example, the actuation module(s) 350 can be configured to keep track of which actuation profile(s) and/or user preferences are being used in connection with a particular user, including based on age, race, gender, geography, health condition, health status, and/or other factors. In some arrangements, the actuation module(s) 350 can be configured to detect, identify, and/or flag actuation profile(s) of celebrities or famous individuals.

Based on the data received by the actuation module(s) 350, the actuation module(s) 350 can send an actuation message 315 and/or a suggested actuation profile 317 to one or more of the connected vehicles 320. As an example, the actuation message 315 may indicate that a certain famous person is using and/or has created a particular actuation profile. The actuation message 315 can include the actuation profile (e.g., the suggested actuation profile 317) so that occupant(s) of the connected vehicle(s) 320 can decide whether to try the profile. In some instances, the actuation module(s) 350 can send the suggested actuation profile 317 to one or more connected vehicles (e.g., all connected vehicles or any subset thereof) for implementation, either automatically or in response to a user's permission.

As another example, the actuation message 315 and/or suggested actuation profile 317 can present an actuation profile that is trending across a population of users, or it can present the most popular profile among a population of users. These messages can be based on a general population or with respect to a certain segment of the general population. For instance, the actuation message 315 and/or the suggested actuation profile 317 can be sent to connected vehicles 320 that are Toyota Prius, and the actuation message 315 and/or the suggested actuation profile 317 can present popular and/or trending actuation profiles amount Toyota Prius users. As another example, the actuation message 315 and/or the suggested actuation profile 317 can be sent to users within a certain age range or bracket. For instance, the actuation message 315 and/or the suggested actuation profile 317 can be sent to users in the 40-49 or other age bracket, indicating popular and/or trending actuation profiles of users in the relevant age bracket.

In some arrangements, the actuation message 315 and/or the suggested actuation profile 317 can be an average actuation profile among the population of connected vehicle 320 or any subset thereof. In some arrangements, the actuation message 315 can be health related. For example, the actuation message 315 and/or the suggested actuation profile 317 can present an actuation profile that is popular or trending among users with a particular health condition or state. In any of the above examples, the actuation message 315 and/or the suggested actuation profile 317 can be sent to relevant users based on information provided to the actuation module(s) 350 by the connected vehicle(s) 320, individual users, and/or personal devices of the individual users.

In some instances, if a user creates a new actuation profile that has not previously been created, the system 300 can send an actuation message 315 or the new actuation profile to the connected vehicle(s) 320, informing the occupant(s) of the new actuation profile.

In some arrangements, the actuation message 315 and/or the suggested actuation profile 317 can be presented to a user to device whether or not to implement the profile. In other arrangements, the actuation message 315 and/or the suggested actuation profile 317 can be a command to the connected vehicle(s) 320 to automatically implement the actuation profile. Any feedback from the user(s) can be sent to the actuation module(s) 350.

The actuation module(s) 350 can be configured to predict an actuation profile for a user. Predictions can be made using user inputs, preferences, history, likes, dislikes, health information, biometrics, user context data, other information, and/or any combination thereof.

In some arrangements, the actuation module(s) 350 can be configured to support user wellness. For instance, the actuation module(s) 350 can cause an actuation profile to be created, modified, and/or implemented to support the wellness of a user. For instance, the actuation module(s) 350 can index an existing massaging seat actuation profile against user health or wellness information, such as that obtained by the personal device(s) 270. For instance, the actuation module(s) 350 can be provided with a user's sleep score. Based on the quality of a user's sleep, the actuation module(s) 350 can modify an existing actuation profile and/or create a new actuation profile.

As another example, the actuation module(s) 350 can understand a user's life activities, such as based on information received from the personal device(s) 270. For instance, if the actuation module(s) 350 can recognize that the user just completed a long flight. The actuation module(s) 350 can recognize that the user is jetlagged and it can modify an existing actuation profile and/or create a new actuation profile to accommodate the user. Alternatively or additionally, the actuation module(s) 350 can recognize that certain areas of the body may be cramped or sore from such a long flight, and it can modify an existing actuation profile and/or create a new actuation profile to accommodate the user.

As another example, the actuation module(s) 350 can recognize that a user was recently at the gym. The actuation module(s) 350 may even understand the type of activities done by the user at the gym. For instance, the actuation module(s) 350 can understand that the user was lifting weights at the gym or focused on a particular area of the body. The actuation module(s) 350 can modify an existing actuation profile by making it gentler on those portions of the body.

Now that the various potential systems, devices, elements and/or components of the system 200 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

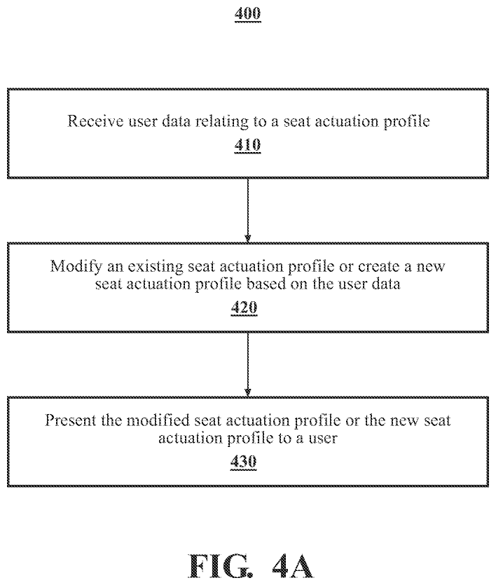

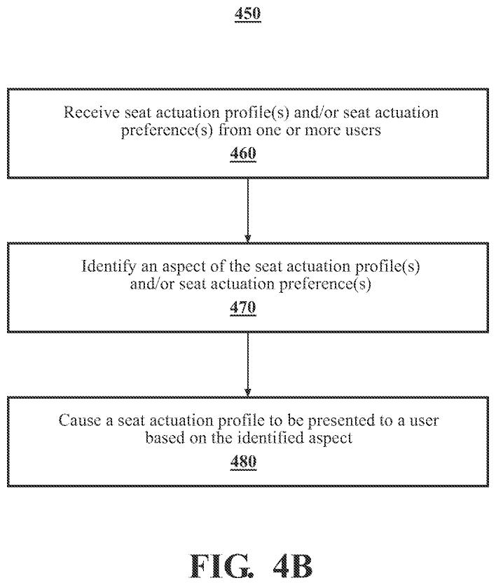

Turning to FIG. 4A, a first example of a method 400 for customized seat actuation is shown. At block 410, user data relating to a seat actuation profile can be received. The user data can be received by the processor(s) 210 and/or the control module(s) 280. The user data can be received from the sensor(s) 230, the personal device(s) 270, and/or the input interface(s) 250. The method 400 can continue to block 420.

At block 420, an existing seat actuation profile can be modified or a new seat actuation profile can be created based on the user data. Such modifying or creating can be performed by the processor(s) 210 and/or the control module(s) 280. The method 400 can continue to block 430.

At block 430, the modified existing seat actuation profile or the new seat actuation profile can be caused to be presented to a user. Such causing can be performed by the processor(s) 210 and/or the control module(s) 280. Presenting the modified existing seat actuation profile or the new seat actuation profile can include displaying a message on the output interface(s) 255. For instance, the message can be presented visually on a display and/or on a speaker. Alternatively or additionally, presenting the modified existing seat actuation profile or the new seat actuation profile can include causing the modified seat actuation profile or the new seat actuation profile to be automatically implemented. For instance, the processor(s) and/or the control module(s) 280 can selectively activate or deactivate one or more seat actuators in accordance with the modified seat actuation profile or the new seat actuation profile. In some instances, the processor(s) and/or the control module(s) 280 can prompt a user for permission to cause the modified existing seat actuation profile or the new seat actuation profile to be implemented.

The method 400 can end. Alternatively, the method 400 can return to block 410 or to some other block. The method 400 can be repeated at any suitable point, such as at a suitable time or upon the occurrence of any suitable event or condition. In some arrangements, a user can provide feedback on the modified existing seat actuation profile or the new seat actuation profile. For instance, a user can indicate whether he or she likes the modified existing seat actuation profile or the new seat actuation profile as a whole or with respect to one or more portions thereof. Such feedback can be provided on the input interface(s) 250.

Turning to FIG. 4B, a second example of a method 450 for customized seat actuation is shown. At block 460, one or more seat actuation profiles and/or one or more seat actuation preferences can be received from one or more of users. The seat actuation profile(s) and/or the seat actuation preference(s) can be received by the processor(s) 330 and/or the actuation module(s) 350. The seat actuation profile(s) and/or the seat actuation preference(s) can be received from the connected vehicle(s) 320 and/or the connected personal device(s) 325. The method 450 can continue to block 470.

At block 470, an aspect of the seat actuation profile(s) and/or the seat actuation preference(s) can be identified. Such identifying can be performed by the server(s) 310, the processor(s) 330, and/or the actuation module(s) 350. The aspect can be identified with respect to all users or any subset thereof. For instance, the aspect can be identified with respect to one or more users of a particular make, model, and/or manufacturer of vehicle. As another example, the aspect can be identified with respect to a particular user, such as a celebrity. The aspect can be a trending actuation profile or preference, a trending portion of an actuation profile, a popular actuation profile or preference, an average actuation profile, or any other aspect. The method 450 can continue to block 480.

At block 480, a seat actuation profile can be caused to be presented to a user based on the identified aspect. Such causing can be performed by the server(s) 310, the processor(s) 330, and/or the actuation module(s) 350. Presenting the seat actuation profile can include presenting a visual and/or an audial message to a user. Alternatively or additionally, presenting the seat actuation profile can include automatically causing the seat actuation profile to be implemented. For instance, the server(s) 310, the processor(s) 330, and/or the actuation module(s) 350 can selectively activate or deactivate one or more seat actuators in accordance with the modified seat actuation profile or the new seat actuation profile. In some instances, the processor(s) and/or the control module(s) 280 can prompt a user for permission to cause the modified existing seat actuation profile or the new seat actuation profile to be implemented.

The method 400 can end. Alternatively, the method 400 can return to block 410 or to some other block. The method 400 can be repeated at any suitable point, such as at a suitable time or upon the occurrence of any suitable event or condition. In some arrangements, a user can provide feedback on the modified existing seat actuation profile or the new seat actuation profile. For instance, a user can indicate whether he or she likes the modified existing seat actuation profile or the new seat actuation profile as a whole or with respect to one or more portions thereof. Such feedback can be provided on the input interface(s) 250.

The method 450 can end. Alternatively, the method 450 can return to block 460 or to some other block. The method 450 can be repeated at any suitable point, such as at a suitable time or upon the occurrence of any suitable event or condition.

There can be a third example of a method for customized seat actuation is shown. Vehicle data and/or environmental data can be received from one or more sources. For example, the vehicle data can be received from the vehicle system(s) 275. As a further example, the vehicle data can be received from the vehicle sensor(s) 234. Still further, the environmental data can be received by the environmental sensor(s) 236. The vehicle data and/or environmental data can be received by the processor(s) 210 and/or the control module(s) 280.

An existing seat actuation profile can be modified or a new seat actuation profile can be created based on the vehicle data and/or environmental data. Such modifying or creating can be performed by the processor(s) 210 and/or the control module(s) 280.

The modified existing seat actuation profile or the new seat actuation profile can be caused to be presented to a user. Such causing can be performed by the processor(s) and/or the control module(s) 280. Presenting the modified existing seat actuation profile or the new seat actuation profile can include displaying a message on the output interface(s) 255. For instance, the message can be presented visually on a display and/or on a speaker. Alternatively or additionally, presenting the modified existing seat actuation profile or the new seat actuation profile can include causing the modified seat actuation profile or the new seat actuation profile to be automatically implemented. For instance, the processor(s) 210 and/or the control module(s) 280 can selectively activate or deactivate one or more the seat actuator(s) 120 in accordance with the modified seat actuation profile or the new seat actuation profile. In some instances, the processor(s) 210 and/or the control module(s) 280 can prompt a user for permission to cause the modified existing seat actuation profile or the new seat actuation profile to be implemented.

The method can end. Alternatively, the method can return to any point in the method. The method can be repeated at any suitable point, such as at a suitable time or upon the occurrence of any suitable event or condition. In some arrangements, a user can provide feedback on the modified existing seat actuation profile or the new seat actuation profile. For instance, a user can indicate whether he or she likes the modified existing seat actuation profile or the new seat actuation profile as a whole or with respect to one or more portions thereof. Such feedback can be provided on the input interface(s) 250.

As noted above, arrangements described herein can be customized by a user. Thus, a user can define a new actuation profile, or the user can modify an existing actuation profile. A user can adjust a currently implemented actuation profile in real-time. Arrangements described herein can enable a user to program individual seat actuators 120 and/or or a plurality of seat actuators 120. Arrangements described herein can enable a user to define one or more programs, attributes, characteristics, and/or settings of individual seat actuators 120 or any grouping of a plurality of the seat actuators 120. Such customization can be effectuated in various ways.

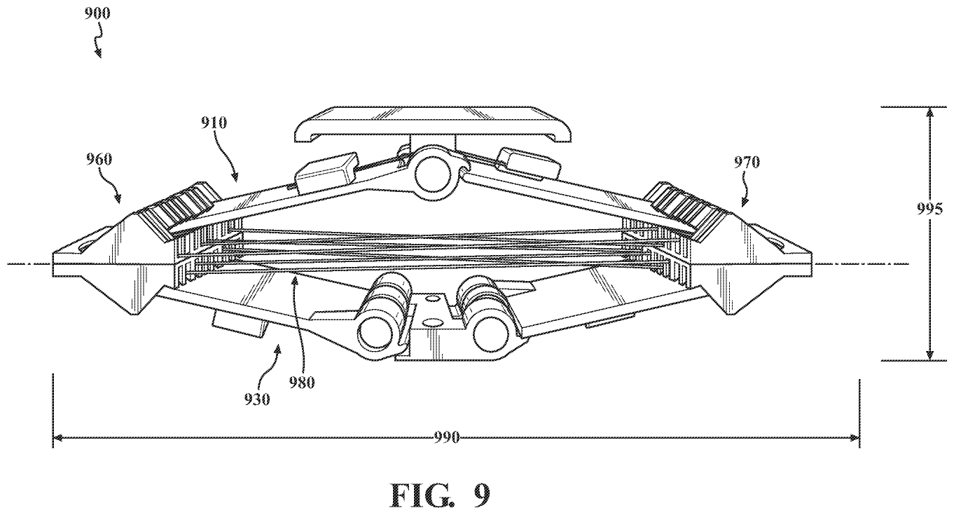

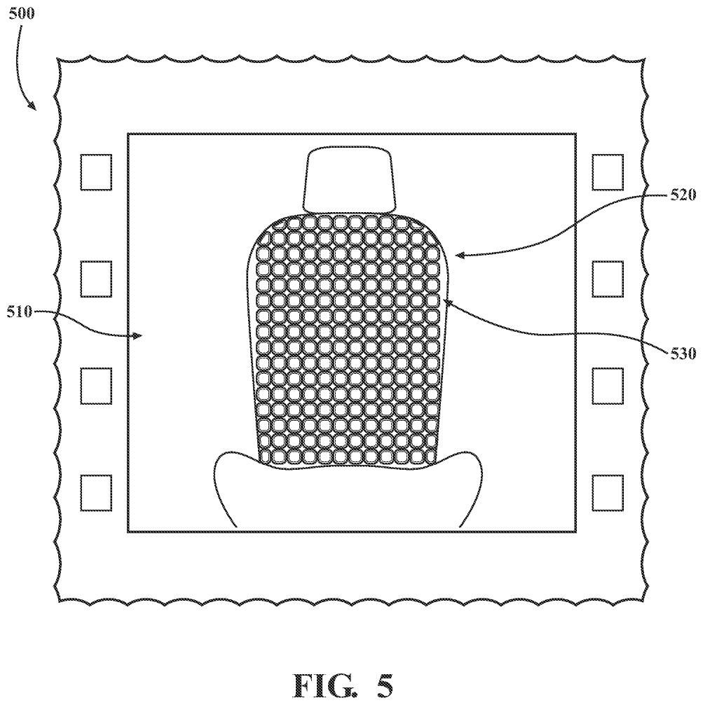

FIG. 5 shows one example in which a user interface is presented on a display 500. The display 500 can be a part of the output interface(s) 255 and/or the input interface(s) 250 of the system 200. In one or more arrangements, the display 500 can be part of a vehicle infotainment system or head unit of a vehicle. In some arrangements, the display 500 can be a portion of another vehicle system, such as a navigation system, a vehicle radio or audio system, a backup camera display, and/or other vehicle monitor. In one or more arrangements, the display 500 can be located in a front interior portion of the vehicle. For instance, the display 500 can be included in a dashboard or instrument panel of the vehicle. Of course, it will be appreciated that arrangements described herein can be customized using other user interfaces, such as on the personal device(s) 270, a voice interface, a gesture interface, a multi-media system or device, etc. Thus, it will be appreciated that there are numerous ways in which a user can interact with the various arrangements described herein.

The display 500 can be any suitable type of display, now known or later developed. In one or more arrangements, the display 500 can be a touch screen display, which can allow a user to engage or interact with one or more displayed elements, such as a graphical user interface (GUI) 510, and/or other applications running on any vehicle system, including any of those described herein, through contact with the forward display. For example, a user may make selections and/or move a cursor by simply touching the display 500 via a finger or stylus.

In the example shown in FIG. 5, the GUI 510 can present a representation of at least a portion of the seat 520. A representation of a plurality of seat actuators 530 can be presented on the representation of the seat 520. The representation of the plurality of seat actuators 530 can correspond to the location of the seat actuators (e.g., seat actuators 120) associated with the seat (e.g., seat 100) of the vehicle. The GUI 510 can be presented automatically whenever the seat actuators are in use, when requested by a user, or upon some other condition or event.

In some arrangements, the GUI 510 can be configured to present a currently in use activation profile. The GUI can show which of the actuators are activated, such as by highlighting them. The GUI 510 can be updated in real time to show changes in the actuators. Additional or alternative effects can be used to represent a status or condition of the actuators.

In some arrangements, the GUI 510 can allow a user to define a new activation profile and/or modify an existing activation profile. The GUI 510 can allow a user to select all of the seat actuators, individual seat actuators, a plurality of seat actuators, one or more rows of seat actuators, one or more columns of seat actuators, one or more regions of seat actuators, any other subset of the seat actuators, or any combination thereof. When a selection of one or more seat actuators is made, a user can assign one or more settings, conditions, parameters, or attributes for the selected actuators. The settings can include activation time, activation duration, activation patterns (e.g., pulses), activation strength, activation speed, activation degree, activation sequence, other activation settings, and any combination thereof. The settings can include coordination and/or choreography between two or more of the selected actuators. The user inputs can be saved as an actuation profile.

In some instances, the GUI 510 can present a suggested activation profile to a user. The user can try the actuation profile, decline the activation profile, or modify the actuation profile. The actuation profile can be saved to the data store(s) 220 and/or to the data store 340.

In this example, the seat actuators are shown in the back portion of the seat. However, it will be appreciated that the arrangements described herein are not limited in this regard. Indeed, the GUI 510 can represent actuators in other areas of the representation of the seat, such as in the headrest, seat portion, bolter(s), arm rest(s), or any other portion of the seat. The GUI 510 can allow a user to select other areas of the seat. In such case, the representation of the seat can change, if needed, to show the plurality actuators associated with the selected area. For instance, if the user selects the seat portion, then a top view of the seat portion can be presented so that the user can see the various actuators associated with the seat portion. It will be appreciated that an actuation profile can cover one or more areas of the seat. In some instances, an actuation profile can cover all areas of the seat.

As noted above, there can be a plurality of seat actuators. The seat actuators can be substantially identical to each other. Alternatively, one or more of the seat actuators can be different from the other seat actuators in one or more respects. FIGS. 6-9 show some non-limiting examples of suitable seat actuators.

FIGS. 6A-6C show one example of an actuator 600 suitable for use in connection with arrangements described herein. The basic details of the actuator 600 will now be described. Additional details of the actuator 600 are described in U.S. Pat. No. 10,960,793, which is incorporated herein by reference in its entirety.

The actuator 600 is depicted here with an outer skin 610, hinge assemblies 620, and an input-responsive element 630. The actuator 600 can have a first dimension 640 and a second dimension 650.

The input-responsive element 630 can include one or more elements capable of transitioning from a first configuration to a second configuration. The transition of the input-responsive element 630 from the first configuration to the second configuration displaces the hinge assemblies 620 with respect to the outer skin 610 and causes a change in confirmation of the outer skin 610. In some implementations, the input-responsive element 630 can include a SMM wire 632. The SMM wire 632 can be a shape memory alloy.

FIG. 6A shows an example of the actuator 600 in a non-activated configuration. When heated, the SMM wire 632 can contract, causing the hinge assemblies 620 to move toward one another. As a result, the actuator 600 can morph from a non-activated configuration to an activated configuration as shown in FIG. 6C. In the activated configuration, the second dimension 650 of the actuator can increase, and the first dimension 640 of the actuator 600 can decrease.

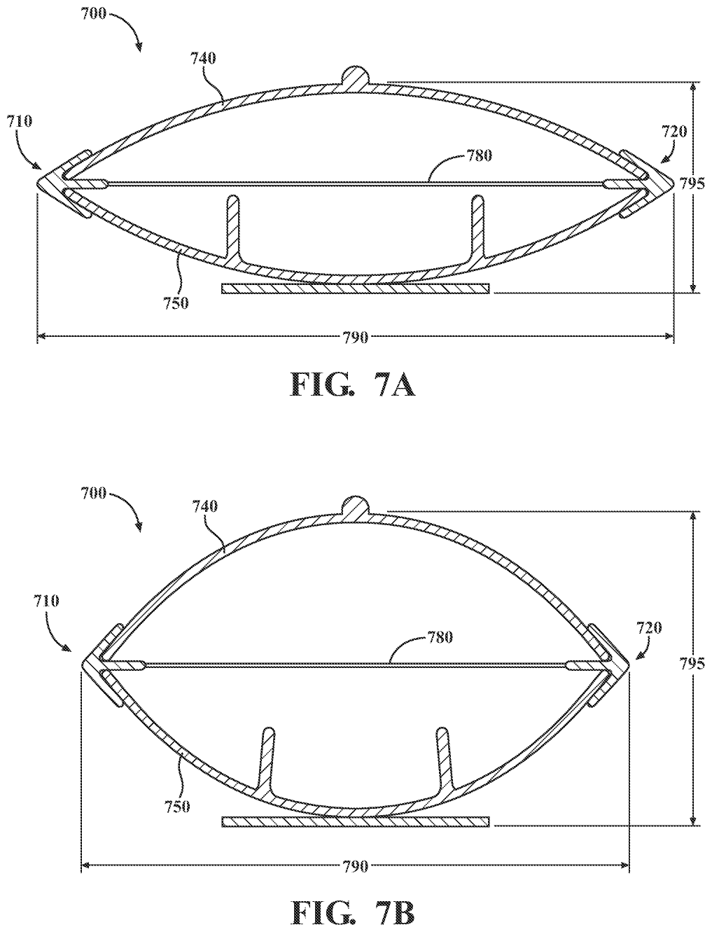

FIGS. 7A-7B show another example of an actuator 700 suitable for use in connection with arrangements described herein. The basic details of the actuator 700 will now be described. Additional details of the actuator 700 are described in U.S. patent application Ser. No. 17/729,522, which is incorporated herein by reference. FIG. 7A shows an example of the actuator 700 in a non-activated condition, and FIG. 7B shows an example of the actuator 700 in an activated condition.

The actuator 700 can include a first endcap 710 and a second endcap 720. The first endcap 710 and the second endcap 720 can be spaced apart. The actuator 700 can include a first outer member 740 and a second outer member 750. The first outer member 740 and the second outer member 750 can have a bowed shape.

The actuator 700 can include one or more shape memory material members 780. The shape memory material members 780 can be operatively connected to the first endcap 710 and the second endcap 720. The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members 780 can be shape memory material wires. As an example, the shape memory material members 780 can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

As noted above, FIG. 7B is an example of the actuator 700 in an activated condition. When an activation input (e.g., electrical energy) is provided to the shape memory material member(s) 780, the shape memory material member(s) 780 can contract. This contraction causes the shape memory material member(s) 780 to pull the first endcap 710 and the second endcap 720 toward each other in a direction that corresponds to the first dimension 790.

Consequently, the ends of the first outer member 740 can be drawn toward each other in a direction that corresponds to the first dimension 790, and the ends of the second outer member 750 can be drawn toward each other in a direction that corresponds to the first dimension 790. As a result, the first outer member 740 and the second outer member 750 can bow outward and away from each other in a direction that corresponds to the second dimension 795. It will be appreciated that the first dimension 790 (i.e., the width) of the actuator 700 can decrease, and the second dimension 795 (i.e., the height) of the actuator 700 can increase.

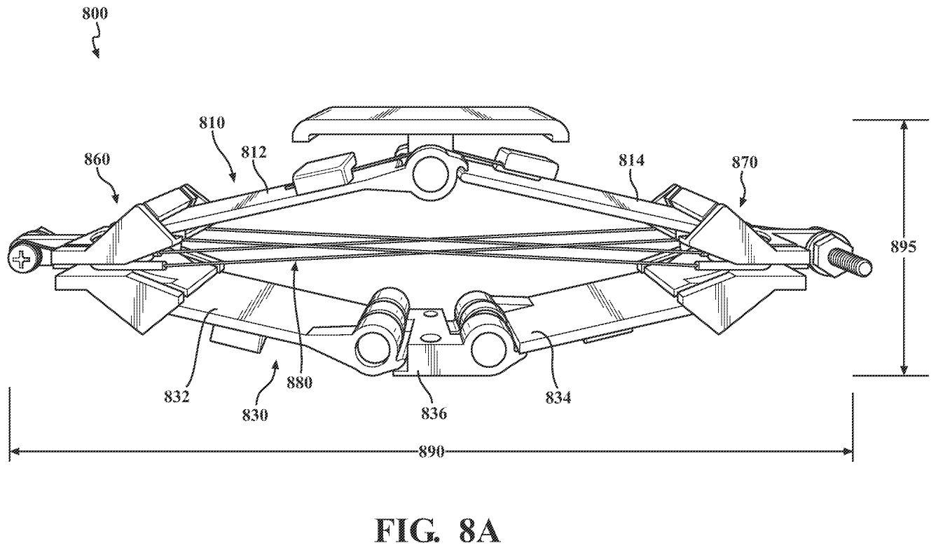

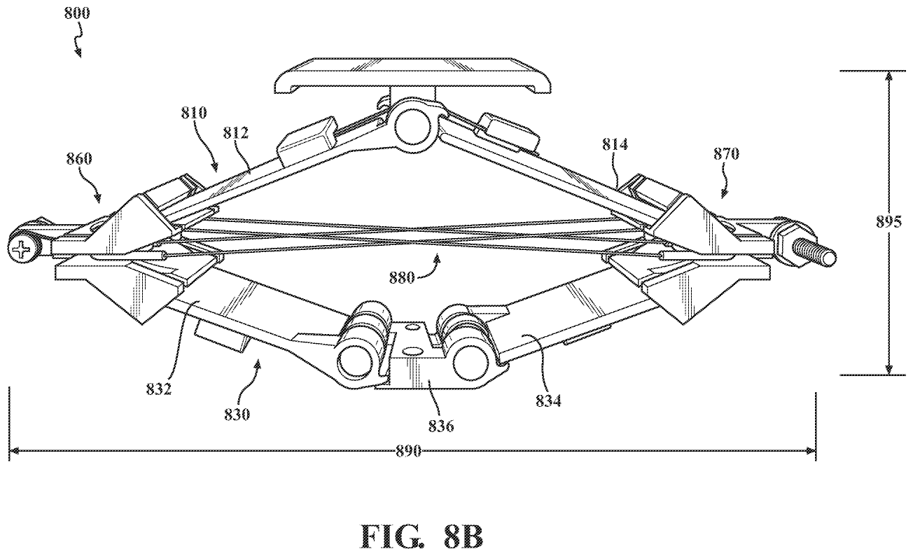

FIGS. 8A-8B show one example of an actuator 800 suitable for use according to arrangements herein. The basic details of the actuator 800 will now be described. Additional details of the actuator 800 are described in U.S. patent application Ser. No. 18/329,217, which is incorporated herein by reference.

The actuator 800 can include a first outer body member 810, a second outer body member 830, a first endcap 860, a second endcap 870, and a shape memory material member 880. The first outer body member 810 can include a first portion 812 and a second portion 814. The first portion 812 and the second portion 814 can be operatively connected to each other such that the first portion 812 and the second portion 814 can move relative to each other. In one or more arrangements, the first portion 812 and the second portion 814 can be pivotably connected to each other. For example, the first portion 812 and the second portion 814 can be pivotably connected to each other by one or more hinges. The first portion 812 and the second portion 814 can be angled relative to each other. As a result, the first outer body member 810 can have a generally V-shape.

The second outer body member 830 can include a first portion 832, a second portion 834, and a base 836. In one or more arrangements, each of the first portion 832 and the second portion 834 can be pivotably connected to the base 836. For example, the first portion 832 can be pivotably connected to the base 836 by one or more hinges, and the second portion 834 can be pivotably connected to the base 836 by one or more hinges. The first portion 832 and the second portion 834 can be located on opposite sides of the base 836.

The actuator 800 can include a first endcap 860 and a second endcap 870. The first endcap 860 and the second endcap 870 can be spaced apart. The actuator 800 can include one or more shape memory material members 880. The shape memory material member(s) 880 can extend between the first endcap 860 and the second endcap 870 in any suitable manner. The shape memory material member(s) 880 can be operatively connected to the first endcap 860 and the second endcap 870.

FIG. 8A shows an example of the actuator 800 in a non-activated configuration. Here, the shape memory material member(s) 880 are not activated. FIG. 8B shows an example of the actuator 800 in an activated configuration. When an activation input (e.g., electrical energy) is provided to the shape memory material member(s) 880, the shape memory material member(s) 880 can contract. This contraction causes the shape memory material member(s) 880 to pull the first endcap 860 and the second endcap 870 toward each other in a direction that corresponds to a first dimension 890. As a result, the first outer body member 810 and the second outer body member 830 can extend outward and away from each other in a direction that corresponds to a second dimension 895. It will be appreciated that, in going from the non-activated condition to the activated condition, the first dimension 890 (i.e., the width) of the actuator 800 can decrease and/or the second dimension 895 (i.e., the height) of the actuator 800 can increase. Further, it will be appreciated that the actuator 800 can deliver a force in a direction that is out of plane or otherwise different from the direction of contraction of the shape memory material member(s) 880.

FIG. 9 shows one example of an actuator 900 suitable for use according to arrangements herein. The basic details of the actuator 900 will now be described. Additional details of the actuator 900 are described in U.S. patent application Ser. No. 18/329,217, which is incorporated herein by reference.

The actuator 900 can include a first outer body member 910, a second outer body member 930, and one or more shape memory material members 980. The actuator 900 includes a first endcap 960 and a second endcap 970. The first endcap 960 and the second endcap 970 shown in FIG. 10 are different than the first endcap 860 and the second endcap 870 shown in FIGS. 8A-8B.

FIG. 9 shows an example of the actuator 900 in a non-activated configuration. Here, the shape memory material member(s) 980 are not activated. When an activation input (e.g., electrical energy) is provided to the shape memory material member(s) 980, the shape memory material member(s) 980 can contract. This contraction causes the shape memory material member(s) 980 to pull the first endcap 960 and the second endcap 970 toward each other in a direction that corresponds to the first dimension 990. As a result, the first outer body member 910 and the second outer body member 930 can extend outward and away from each other in a direction that corresponds to the second dimension 995. It will be appreciated that, in going from the non-activated condition to the activated condition, the first dimension 990 (i.e., the width) of the actuator 900 can decrease and/or the second dimension 995 (i.e., the height) of the actuator 900 can increase.

The various examples of actuators shown in FIGS. 6-9 are merely examples and are not intended to be limiting. Other actuators are described in U.S. Patent Publication Nos. 2023/0191953 and 2023/0136197 as well as U.S. Pat. Nos. 11,370,330; 11,285,844; and 11,091,060, which are incorporated herein by reference in their entireties.

It will be appreciated that arrangements described herein can provide numerous benefits, including one or more of the benefits mentioned herein. For example, arrangements described herein can provide a customized experience for a seat occupant. Arrangements described here can account for user feedback to enhance a user's experience. Arrangements described here can support a user's wellness. Arrangements described here can provide a user with suggestions on seat actuation profiles based on the usage of others. Arrangements described herein can provide an enhanced haptic effect. Arrangements described herein can enable a high degree of customization and/or programmability to a user. Arrangements described herein can provide flexibility and granularity in customizing the seat actuators. Arrangements described herein can facilitate user interaction with seat actuation.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A method for seat actuation comprising:
receiving user data relating to a seat actuation profile; and
modifying a seat actuation profile or creating a new seat actuation profile based on the user data; and
causing the modified seat actuation profile or the new seat actuation profile to be presented to a user.

2. The method of claim 1, wherein the user data includes a user input.

3. The method of claim 2, wherein the user input is a like or dislike about a seat actuation profile or a portion of a seat actuation profile.

4. The method of claim 1, wherein the user data is received from a personal device.

5. The method of claim 4, wherein the user data includes user health information.

6. The method of claim 4, wherein the user data includes user context data.

7. The method of claim 1, wherein the user data is received from a seat occupant sensor.

8. The method of claim 1, wherein causing the modified seat actuation profile or the new seat actuation profile to be implemented includes automatically causing the modified seat actuation profile or the new seat actuation profile to be implemented, whereby one or more actuators operatively connected to a seat are selectively activated and/or deactivated in accordance with the modified seat actuation profile or the new seat actuation profile.

9. The method of claim 1, further including receiving user feedback from a user about the modified seat actuation profile or the new seat actuation profile or a portion thereof.

10. A system for seat actuation comprising:
a seat;
an actuator operatively connected to the seat; and
one or more processors operatively connected to the actuator, the one or more processors being programmed to initiate executable operations comprising:
receiving user data relating to a seat actuation profile; and
modifying a seat actuation profile or creating a new seat actuation profile based on the user data; and
causing the modified seat actuation profile or the new seat actuation profile to be presented to a user.

11. The system of claim 10, wherein the one or more processors are located onboard a vehicle.

12. The system of claim 10, further including a user interface, and wherein the user data includes a user input provided on the user interface.

13. The system of claim 12, wherein the user input is a like or dislike about a seat actuation profile or a portion of a seat actuation profile.

14. The system of claim 10, wherein the user data is received from a personal device operatively connected to the one or more processors.

15. The system of claim 14, wherein the user data includes user health information.

16. The system of claim 14, wherein the user data includes user context data.

17. The system of claim 10, further including a seat occupant sensor configured to acquire user data from a seat occupant, wherein the seat occupant sensor is operatively connected to the one or more processors, and wherein the user data is received from the seat occupant sensor.

18. The system of claim 10, wherein causing the modified seat actuation profile or the new seat actuation profile to be implemented includes automatically causing the modified seat actuation profile or the new seat actuation profile to be implemented, whereby the actuator is selectively activated or deactivated in accordance with the modified seat actuation profile or the new seat actuation profile.

19. The system of claim 10, wherein the executable operations further include:
receiving user feedback from a user about the modified seat actuation profile or the new seat actuation profile or a portion thereof.

20. A seat actuation method comprising;
receiving one or more seat actuation profiles and/or one or more seat actuation preferences from one or more users;
identifying an aspect of the one or more seat actuation profiles and/or the one or more seat actuation preferences; and
causing a seat actuation profile to be presented to a user based on the aspect.

21. The seat actuation method of claim 20, wherein the aspect is a seat actuation profile or a seat actuation preference of a celebrity.

22. The seat actuation method of claim 20, wherein the aspect is a trend among a plurality of users.

23. The seat actuation method of claim 20, wherein the aspect is a most popular seat actuation profile among a plurality of users.

24. The seat actuation method of claim 23, wherein causing a seat actuation profile to be presented to a user based on the aspect includes automatically causing the seat actuation profile to be implemented.

25. The seat actuation method of claim 20, further including:
receiving user feedback from a user about the seat actuation profile.

26. A system for seat actuation comprising:
one or more processors operatively connected to one or more connected entities, the one or more processors being programmed to initiate executable operations comprising:
receiving one or more seat actuation profiles and/or one or more seat actuation preferences from one or more users;
identifying an aspect of the one or more seat actuation profiles and/or the one or more seat actuation preferences; and
causing a seat actuation profile to be presented to a user based on the aspect.

27. The system of claim 26, wherein the connected entities include at least one of vehicles and personal devices.

28. The system of claim 26, wherein the one or more processors are located remote from the one or more connected entities.

29. The system of claim 26, wherein causing a seat actuation profile to be presented to a user based on the aspect includes causing a notification to be sent to a connected entity.

30. The system of claim 26, wherein causing a seat actuation profile to be presented to a user based on the aspect includes automatically causing the seat actuation profile to be implemented.

31. The system of claim 26, wherein the aspect is a seat actuation profile or a seat actuation preference of a celebrity.

32. The system of claim 26, wherein the aspect is a trend among a plurality of users.

33. The system of claim 26, wherein the aspect is a most popular seat actuation profile among a plurality of users.

34. The system of claim 26, wherein the executable operations further include receiving user feedback from a user about the seat actuation profile.

35. A method for actuation of a seat in a vehicle, the method comprising:
receiving vehicle data and/or environmental data; and
modifying a seat actuation profile or creating a new seat actuation profile based on the vehicle data and/or the environmental data; and
causing the modified seat actuation profile or the new seat actuation profile to be presented to a user.

36. The method of claim 35, wherein the environmental data is received from one or more environmental sensors.

37. The method of claim 36, wherein the environmental data includes information about an environment of a cabin of a vehicle.

38. The method of claim 36, wherein the environmental data includes information about an external environment of a vehicle.

39. The method of claim 35, wherein the vehicle data is received from one or more vehicle systems.

40. A system for seat actuation comprising:
a seat;
an actuator operatively connected to the seat; and
one or more processors operatively connected to the actuator, the one or more processors being programmed to initiate executable operations comprising:
receiving vehicle data and/or environmental data;
modifying a seat actuation profile or creating a new seat actuation profile based on the vehicle data and/or environmental data; and
causing the modified seat actuation profile or the new seat actuation profile to be presented to a user.

41. The system of claim 40, further including a vehicle system operatively connected to the one or more processors, and wherein the vehicle data is received from the vehicle system.

42. The system of claim 40, further including a vehicle sensor operatively connected to the one or more processors, and wherein the vehicle data is received from the vehicle sensor.

43. The system of claim 40, further including an environmental sensor operatively connected to the one or more processors, and wherein the environmental data is received from the environmental sensor.

44. The system of claim 40, wherein the environmental data includes information about an environment of a cabin of a vehicle.

45. The system of claim 40, wherein the environmental data includes information about an external environment of a vehicle.
